(19) United States
(12) Patent Application Publication
(10) Pub. No.: US 2017/0240182 A1
(43) Pub. Date: Aug. 24, 2017

(54) VEHICLE CONTROL SYSTEM, VEHICLE CONTROL METHOD, AND VEHICLE CONTROL PROGRAM

(71) Applicant: Honda Motor Co., Ltd., Tokyo (JP)

(72) Inventor: Kunimichi Hatano, Wako-shi (JP)

(73) Assignee: Honda Motor Co., Ltd., Tokyo (JP)

(21) Appl. No.: 15/425,147

(22) Filed: Feb. 6, 2017

(30) Foreign Application Priority Data
Feb. 18, 2016 (JP) 2016-029049

(51) Int. Cl. B60W 50/06; B60W 30/10; B60W 50/08; B60W 10/18; B60W 30/18; B60W 10/20; B60W 10/04

(52) U.S. Cl. CPC B60W 50/06; B60W 10/20; B60W 30/10; B60W 10/04; B60W 10/18; B60W 30/18145; B60W 50/082; B60W 2510/20; B60W 2510/18; B60W 2540/18; B60W 2540/04; B60W 2720/10

(57) ABSTRACT

A vehicle control system includes the following components. An automated driving control unit carries out a first driving mode in which at least one of acceleration/deceleration and steering of a vehicle is automatically controlled. An operation device receives an operation performed by an occupant of the vehicle. A handover control unit instructs shifting to a second driving mode, in which the degree of automated driving is lower than in the first driving mode, when the occupant of the vehicle operates the operation device to instruct one of or both of acceleration/deceleration and steering of the vehicle in the first driving mode. A drive control unit performs acceleration based on an acceleration operation if speed of the vehicle to be achieved as a result of acceleration based on the acceleration operation does not exceed a threshold dependent on a steering angle of the vehicle.

### CROSS REFERENCES TO RELATED APPLICATIONS

The present application claims priority under 35 U.S.C. §119 to Japanese Patent Application No. 2016-029049, filed Feb. 18, 2016, entitled “Vehicle Control System, Vehicle Control Method, and Vehicle Control Program.” The contents of this application are incorporated herein by reference in their entirety.

### TECHNICAL FIELD

The present disclosure relates to a vehicle control system, a vehicle control method, and a vehicle control program.

### BACKGROUND

For example, a technique for detecting a depression state of the accelerator pedal while autocruise driving is being performed and for changing the control mode of autocruise driving in accordance with the detected depression state has been disclosed (see, for example, Japanese Unexamined Patent Application Publication No. 2000-54860).

Research on technologies for automatically controlling at least one of acceleration/deceleration and steering of a vehicle so that the vehicle travels along a route to a destination (hereinafter, referred to as “automated driving”) has been conducted recently.

With the technique of the related art, the driving state may deviate from the state where automated driving can be performed appropriately if a vehicle is accelerated temporarily on the basis of an operation performed by an occupant of the vehicle during automated driving.

### SUMMARY

The present application describes, for example, a vehicle control system, a vehicle control method, and a vehicle control program that enable acceleration to be performed temporarily within an appropriate range during automated driving.

According to a first aspect, there is provided a vehicle control system (1) including an automated driving control unit (110) that carries out a first driving mode in which at least one of acceleration/deceleration and steering of a vehicle is automatically controlled such that the vehicle travels along a route to a destination; an operation device (70, 72, 74) that receives an operation performed by an occupant of the vehicle; a handover control unit (132) that instructs the automated driving control unit to perform shifting to a second driving mode when the occupant of the vehicle performs an operation on the operation device to instruct one of or both of acceleration/deceleration and steering of the vehicle while the automated driving control unit is carrying out the first driving mode, the second driving mode being a mode in which a degree of automated driving is lower than in the first driving mode; and a drive control unit (120) that performs acceleration based on an operation that is performed by the occupant of the vehicle to accelerate the vehicle and that is received by the operation device, if speed of the vehicle to be achieved as a result of the acceleration based on the operation does not exceed a threshold that is dependent on a steering angle of the vehicle.

According to a second aspect, in the vehicle control system according to the first aspect, the drive control unit may maintain the speed of the vehicle at a speed limit that is dependent on the steering angle of the vehicle if the speed of the vehicle to be achieved as a result of the acceleration exceeds the threshold that is dependent on the steering angle of the vehicle.

According to a third aspect, in the vehicle control system according to the first or second aspect, the drive control unit may terminate the first driving mode if the occupant of the vehicle is performing a steering operation on the operation device and the speed of the vehicle exceeds the threshold.

According to a fourth aspect, in the vehicle control system according to any one of the first to third aspects, the drive control unit may be configured not to perform the acceleration based on the operation that is performed to accelerate the vehicle and that is received by the operation device if the vehicle is performing lane changing in the first driving mode.

According to a fifth aspect, in the vehicle control system according to any one of the first to fourth aspects, the drive control unit may terminate the first driving mode if the acceleration operation received by the operation device has been continued for a predetermined period or longer, and may continue the first driving mode if an operation period for which the acceleration operation has been continued is shorter than the predetermined period.

According to a sixth aspect, the vehicle control system according to the second aspect may further include an output unit that outputs information, wherein the drive control unit may cause the output unit to output information indicating that acceleration of the vehicle is limited if the speed of the vehicle to be achieved as a result of the acceleration exceeds the threshold that is dependent on the steering angle of the vehicle and the speed of the vehicle is maintained at the speed limit.

According to a seventh aspect, there is provided a vehicle control method performed by a computer mounted in a vehicle, including carrying out a first driving mode in which at least one of acceleration/deceleration and steering of the vehicle is automatically controlled such that the vehicle travels along a route to a destination; instructing shifting to a second driving mode when an occupant of the vehicle performs an operation on an operation device to instruct one of or both of acceleration/deceleration and steering of the vehicle while the first driving mode is being carried out, the second driving mode being a mode in which a degree of automated driving is lower than in the first driving mode, the operation device being a device that receives an operation performed by the occupant of the vehicle; and performing acceleration based on an operation that is performed by the occupant of the vehicle to accelerate the vehicle and that is received by the operation device, if speed of the vehicle to be achieved as a result of the acceleration based on the operation does not exceed a threshold that is dependent on a steering angle of the vehicle.

According to an eighth aspect, there is provided a vehicle control program causing a computer mounted in a vehicle to execute a process including carrying out a first driving mode in which at least one of acceleration/deceleration and steering of the vehicle is automatically controlled such that the vehicle travels along a route to a destination; instructing shifting to a second driving mode when an occupant of the vehicle performs an operation on an operation device to instruct one of or both of acceleration/deceleration and steering of the vehicle while the first driving mode is being carried out, the second driving mode being a mode in which a degree of automated driving is lower than in the first driving mode, the operation device being a device that receives an operation performed by the occupant of the vehicle; and performing acceleration based on an operation that is performed by the occupant of the vehicle to accelerate the vehicle and that is received by the operation device, if speed of the vehicle to be achieved as a result of the acceleration based on the operation does not exceed a threshold that is dependent on a steering angle of the vehicle. In the above explanation of the exemplary aspects of embodiment, specific elements with their reference numerals are indicated by using brackets. These specific elements are presented as mere examples in order to facilitate understanding, and thus, should not be interpreted as any limitation to the accompanying claims.

According to the first, seventh, and eighth aspects, the vehicle control system, the vehicle control method, and the vehicle control program enable acceleration to be performed temporarily within an appropriate range during automated driving without deviating from the driving state where automated driving can be performed appropriately, in the case where temporary acceleration is performed on the basis of an operation performed by the occupant of the vehicle during automated driving.

According to the second aspect, the vehicle control system successfully prevents acceleration to a speed at which automated driving is not performed appropriately, by maintaining the speed of the vehicle at a speed limit that is dependent on the steering angle of the vehicle if the speed of the vehicle to be achieved as a result of acceleration exceeds the threshold that is dependent on the steering angle of the vehicle.

According to the third aspect, the vehicle control system successfully implements switching control by respecting the intention of the occupant of the vehicle because the vehicle control system quickly switches the driving mode from the first driving mode to the second driving mode when an operation for instructing both acceleration/deceleration operation and steering of the vehicle is received from the occupant of the vehicle.

According to the fourth aspect, the vehicle control system successfully performs automated driving appropriately by not performing acceleration based on the acceleration operation received by the operation device during lane changing. That is, since automated lane changing highly requires the continuity of control, the vehicle control system successfully performs appropriate switching control that meets such a requirement.

According to the fifth aspect, the vehicle control system successfully performs switching of the driving mode appropriately in accordance with the operation period.

According to the sixth aspect, since the vehicle control system successfully allows the occupant of the vehicle to recognize that their manual operation is restrained through a notification issued by the output unit, the vehicle control system successfully performs appropriate driving control without making the occupant of the vehicle feel differently from their familiar manner when the occupant performs the manual operation.

### BRIEF DESCRIPTION OF THE DRAWINGS

The advantages of the disclosure will become apparent in the following description taken in conjunction with the following drawings.

FIG. 1 is a diagram illustrating components of a vehicle in which a vehicle control system according to an embodiment is mounted.

FIG. 2 is a functional configuration diagram of the vehicle control system according to the embodiment.

FIG. 3 is a diagram illustrating how the relative position of a vehicle in a lane where the vehicle is traveling is recognized by a vehicle position recognizing unit.

FIG. 4 is a diagram illustrating an example of an action plan generated for a certain section.

FIGS. 5A to 5D are diagrams each illustrating an example of a path generated by a path generating unit.

FIG. 6 is a diagram illustrating how a target position range is set.

FIG. 7 is a diagram illustrating how a path for lane changing is generated.

FIG. 8 is a diagram illustrating an example of the speed limit that is dependent on the steering angle.

FIG. 9 is a flowchart illustrating an example of a drive control process according to the embodiment.

### DETAILED DESCRIPTION

A vehicle control system, a vehicle control method, and a vehicle control program according to an embodiment of the present disclosure will be described below with reference to the accompanying drawings.

### Configuration of Vehicle

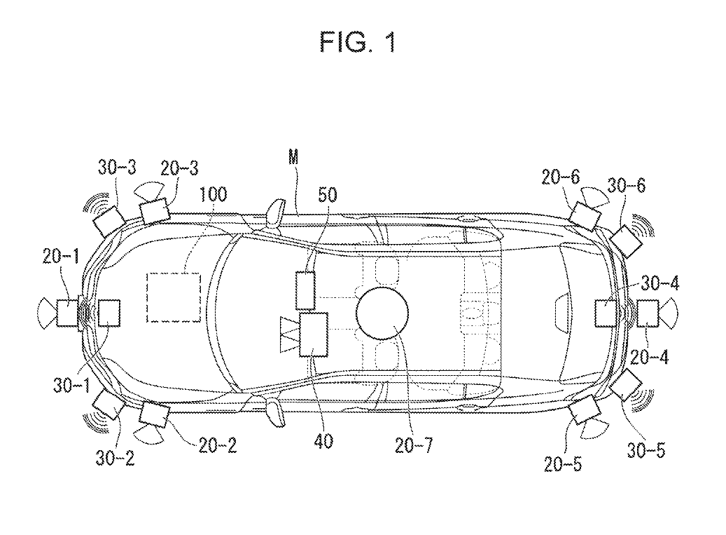

FIG. 1 is a diagram illustrating components of a vehicle (hereinafter, referred to as a “vehicle M”) in which the vehicle control system according to the embodiment is mounted. The vehicle in which a vehicle control device 100 included in the vehicle control system is mounted is a vehicle with two, three, or four wheels, for example. Examples of such a vehicle include a vehicle that uses an internal combustion engine such as a diesel engine or a gasoline engine as its power source, an electric vehicle that uses a motor as its power source, a hybrid vehicle including both an internal combustion engine and a motor, and so forth. In addition, the aforementioned electric vehicle is driven by using electric power obtained by discharge of a battery cell, such as a secondary battery cell, a hydrogen fuel cell, a metal fuel cell, or an alcohol fuel cell, for example.

As illustrated in FIG. 1, the vehicle M includes sensors such as rangefinders 20-1 to 20-7, radars 30-1 to 30-6, and a camera 40; a navigation system 50; and the vehicle control device 100. Each of the rangefinders 20-1 to 20-7 is, for example, a LIDAR (Light Detection and Ranging or Laser Imaging Detection and Ranging) device that measures scattered light of emitted light to measure a distance to a target. For example, the rangefinder 20-1 is attached to the front grille or the like. Each of the rangefinders 20-2 and 20-3 is attached to a side of the body of the vehicle, a sideview mirror, inside of a headlamp, a portion near a side marker lamp, or the like. The rangefinder 20-4 is attached to a trunk lid or the like. Each of the rangefinders 20-5 and 20-6 is attached to a side of the body of the vehicle, inside of a rear position lamp, or the like. The aforementioned rangefinders 20-1 to 20-6 have a horizontal-direction detection range of about 150 degrees, for example. The rangefinder 20-7 is attached to the roof or the like. The rangefinder 20-7 has a horizontal-direction detection range of about 360 degrees, for example.

The aforementioned radars 30-1 and 30-4 are, for example, long-range millimeter wave radars having a wider depth-direction detection range than the other radars. In addition, the radars 30-2, 30-3, 30-5, and 30-6 are middle-range millimeter wave radars having a narrower depth-direction detection range than the radars 30-1 and 30-4. Hereinafter, the rangefinders 20-1 to 20-7 are simply referred to as “rangefinders 20” when they are not particularly distinguished from one another, and the radars 30-1 to 30-6 are simply referred to as “radars 30” when they are not particularly distinguished from one another. Each of the radars 30 detects whether there is an object (for example, a nearby vehicle (another vehicle) or an obstacle) around the vehicle M, and detects the distance to the object and the relative speed or the like by using FM-CW (Frequency Modulated Continuous Wave) method, for example.

The camera 40 is, for example, a digital camera that uses a solid-state imaging element, such as a CCD (Charge Coupled Device) or CMOS (Complementary Metal Oxide Semiconductor) imaging element. The camera 40 is attached to an upper portion of the front windshield, the back surface of the rearview mirror, or the like. The camera 40 periodically captures an image of a scene in front of the vehicle M, for example.

Note that the configuration illustrated in FIG. 1 is merely an example, and part of the configuration may be omitted or another configuration may be further added.

### Functional Configuration

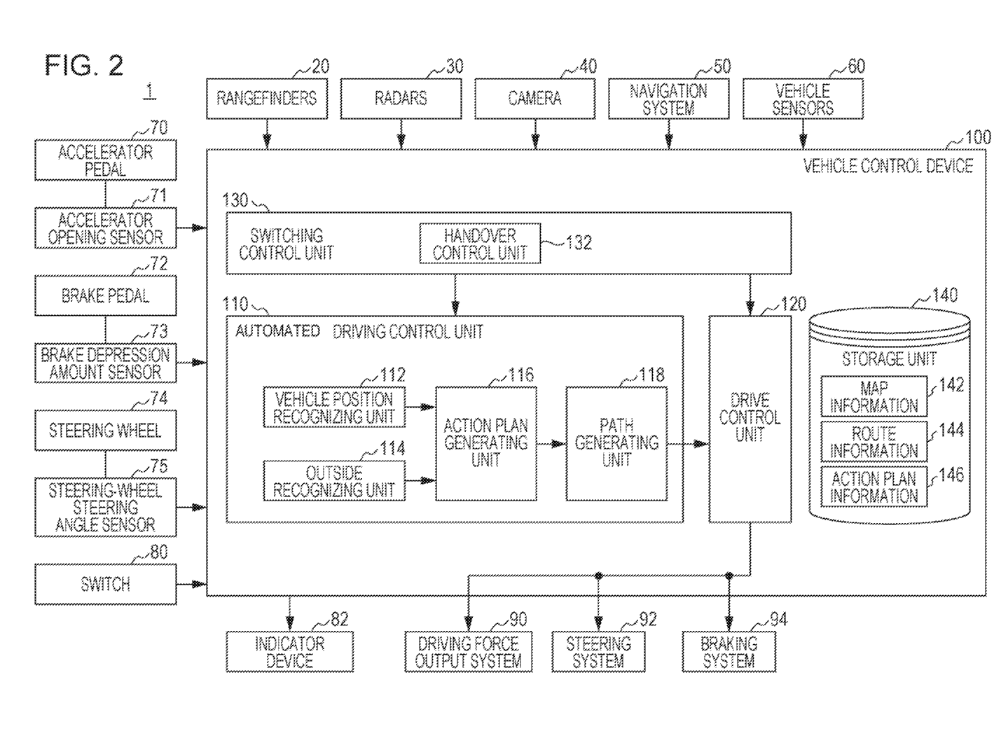

FIG. 2 is a functional configuration diagram of a vehicle control system 1 according to the embodiment. In addition to the rangefinders 20, the radars 30, and the camera 40, the vehicle control system 1 includes the navigation system 50; vehicle sensors 60; operation devices such as an accelerator pedal 70, a brake pedal 72, and a steering wheel 74; operation detection sensors such as an accelerator opening sensor 71, a brake depression amount sensor (brake switch) 73, and a steering-wheel steering angle sensor (or steering torque sensor) 75; a switch 80; an indicator device (output unit) 82; a driving force output system 90, a steering system 92; a braking system 94; and the vehicle control device 100. These systems and devices are connected to one another via a multiplex communication line such as a CAN (Controller Area Network) communication line, a serial communication line, a wireless communication network, or the like. Note that the aforementioned operation devices are merely an example, and the vehicle M may be equipped with a joystick, buttons, a dial switch, or a GUI (Graphical User Interface)-based switch.

The navigation system 50 includes a GNSS (Global Navigation Satellite System) receiver, map information (map for navigation), a touchscreen display device that functions as a user interface, a speaker, and a microphone. The navigation system 50 identifies the location of the vehicle M by using the GNSS receiver and determines a route from the identified location to the destination specified by the user. The route determined by the navigation system 50 is stored as route information 144 in a storage unit 140. The location of the vehicle M may be identified or compensated for by an INS (Inertial Navigation System) that uses the output of the vehicle sensors 60. The navigation system 50 provides the route to the destination by audio or displaying when the vehicle control device 100 is carrying out a manual driving mode. The configuration used to identify the location of the vehicle M may be provided independently from the navigation system 50. In addition, the navigation system 50 may be implemented as one of functions of a user's terminal device, such as a smartphone or tablet terminal, for example. In this case, the terminal device and the vehicle control device 100 exchange information via wired or wireless communication.

The vehicle sensors 60 include a vehicle speed sensor that detects the speed of the vehicle M, an acceleration sensor that detects acceleration, a yaw-rate sensor that detects an angular velocity around the vertical axis, and a direction sensor that detects the direction in which the vehicle M is heading, for example.

The operation detection sensors output detection results such as the accelerator opening, the brake depression amount, and the steering-wheel steering angle to the vehicle control device 100. Instead of this configuration, the detection results obtained by the operation detection sensors may be output directly to the driving force output system 90, the steering system 92, or the braking system 94 depending on the driving mode.

The switch 80 is a switch operated by an occupant of the vehicle M. The switch 80 receives an operation performed by the occupant of the vehicle M and switches the driving mode (between an automated driving mode (first driving mode) and a manual driving mode (second driving mode), for example) in accordance with the received operation. For example, the switch 80 generates a driving mode specifying signal that specifies the driving mode of the vehicle M on the basis of the operation performed by the occupant of the vehicle M and outputs the driving mode specifying signal to a switching control unit 130.

The indicator device 82 is one of various devices capable of outputting information. The indicator device 82 outputs, for example, information that prompts the occupant of the vehicle M to shift from an automated driving mode to a manual driving mode. For example, at least one of a speaker, a vibrator, a display device, and a light-emitting device may be used as the indicator device 82.

For example, the driving force output system 90 includes an engine and an engine ECU (Electronic Control Unit) that controls the engine if the vehicle M is a vehicle that uses an internal combustion engine as its power source. The driving force output system 90 includes a drive motor and a motor ECU that controls the drive motor if the vehicle M is an electric vehicle that uses a motor as its power source. The driving force output system 90 includes an engine, an engine ECU, a drive motor, and a motor ECU if the vehicle M is a hybrid vehicle. If the driving force output system 90 includes an engine alone, the engine ECU adjusts the throttle opening of the engine and the gear in accordance with information input thereto from a drive control unit 120 (described later) and outputs a driving force (torque) that causes the vehicle M to travel. In addition, if the driving force output system 90 includes a drive motor alone, the motor ECU adjusts the duty ratio of a PWM (Pulse Width Modulation) signal supplied to the drive motor in accordance with information input thereto from the drive control unit 120 and outputs the driving force described above. In addition, if the driving force output system 90 includes an engine and a drive motor, the engine ECU and the motor ECU cooperate with each other in accordance with information input thereto from the drive control unit 120 to control the driving force.

The steering system 92 includes, for example, an electric motor. For example, the electric motor applies a force to a rack-and-pinion mechanism to change the direction of steered wheels. The steering system 92 drives the electric motor in accordance with information input thereto from the drive control unit 120 to change the direction of steered wheels.

The braking system 94 is, for example, an electric servo braking system including brake calipers, a cylinder that transmits hydraulic pressure to the brake calipers, an electric motor that produces hydraulic pressure in the cylinder, and a braking control unit. The braking control unit of the electric servo braking system controls the electric motor in accordance with information input thereto from the drive control unit 120 so that a braking torque (braking force output device) that produces a braking force corresponding to a braking operation is output to each wheel. The electric servo braking system may include a backup mechanism that transmits hydraulic pressure produced in response to an operation of the brake pedal to the cylinder via a master cylinder. Note that the braking system 94 is not limited to the electric servo braking system described above and may be an electrically controlled hydraulic braking system. The electrically controlled hydraulic braking system controls an actuator in accordance with information input thereto from the drive control unit 120 and transmits hydraulic pressure at the master cylinder to the cylinder. In addition, the braking system 94 may include a regenerative brake that involves the drive motor that can be included in the driving force output system 90.

### Vehicle Control Device

The vehicle control device 100 will be described below. The vehicle control device 100 includes, for example, an automated driving control unit 110, the drive control unit 120, the switching control unit 130, and the storage unit 140. The automated driving control unit 110 includes, for example, a vehicle position recognizing unit 112, an outside recognizing unit 114, an action plan generating unit 116, and a path generating unit 118. Some or all of the units of the automated driving control unit 110, the drive control unit 120, and the switching control unit 130 are implemented as a result of a processor, such as a CPU (Central Processing Unit), executing a program. In addition, the some or all of the units of the automated driving control unit 110, the drive control unit 120, and the switching control unit 130 may be implemented by hardware, such as an LSI (Large Scale Integration) or ASIC (Application Specific Integrated Circuit) chip. In addition, the storage unit 140 is implemented by a ROM (Read Only Memory), a RAM (Random Access Memory), a HDD (Hard Disk Drive), a flash memory, or the like. A program that is executed by the processor may be stored in the storage unit 140 in advance or may be downloaded from an external device via on-vehicle Internet-connection equipment or the like. In addition, the program may be installed in the storage unit 140 as a result of a portable storage medium storing the program thereon being put in a drive (not illustrated). The vehicle control device 100 may be implemented by a plurality of computers in a distributed manner. In such a way, an on-vehicle computer of the vehicle M is capable of implementing various processes of the embodiment by causing the above-described hardware functional units and software such as the program to cooperate together.

The automated driving control unit 110 performs control by switching the driving mode in accordance with an instruction given from the switching control unit 130. The driving modes include a driving mode (automated driving mode) in which acceleration/deceleration and steering of the vehicle M are automatically controlled and a driving mode (manual driving mode) in which acceleration/deceleration of the vehicle M is controlled on the basis of operations of the operation devices such as the accelerator pedal 70 and the brake pedal 72 and in which steering is controlled on the basis of an operation of the operation device such as the steering wheel 74. The driving modes are not limited to these modes, and the driving modes may include a driving mode (semi-automated driving mode) in which one of acceleration/deceleration and steering of the vehicle M is automatically controlled and the other is controlled on the basis of an operation of the operation device(s).

For example, when the first driving mode is the automated driving mode, the second driving mode may be the manual driving mode or the semi-automated driving mode. When the first driving mode is the semi-automated driving mode, the second driving mode is the manual driving mode. That is, the second driving mode is a mode in which the degree of automated driving is lower than in the first driving mode. The following description will be given on the assumption that the first driving mode is the automated driving mode and the second driving mode is the manual driving mode. When the manual driving mode is carried out, the automated driving control unit 110 may stop operating, and input signals from the operation detection sensors may be supplied to the drive control unit 120 or directly to the driving force output system 90, the steering system 92, or the braking system 94.

The automated driving control unit 110 includes the vehicle position recognizing unit 112, the outside recognizing unit 114, the action plan generating unit 116, and the path generating unit 118. The vehicle position recognizing unit 112 recognizes the lane where the vehicle M is traveling (current lane) and the relative position of the vehicle M in the current lane on the basis of map information 142 stored in the storage unit 140 and information input thereto from the rangefinders 20, the radars 30, the camera 40, the navigation system 50, and the vehicle sensors 60. The map information 142 is, for example, map information having a higher precision than the map for navigation included in the navigation system 50 and includes information concerning the center of each of lanes, the boundary of the lanes, and so forth. More specifically, the map information 142 includes information such as road information, traffic regulation information, address information (addresses/zip codes), facility information, and phone number information. The road information includes information representing the type of the road, such as a highway, a toll road, a national route, or a prefectural road and information such as the number of lanes of the road, the width of each of the lanes, the slope of the road, the location of the road (three-dimensional coordinates including the latitude, the longitude, and the altitude), the curvature of each curve of each lane, the locations of merging and branching points of each lane, and the signs provided at the road. The traffic regulation information includes information concerning each lane that is closed due to a road construction, a traffic accident, or a traffic jam.

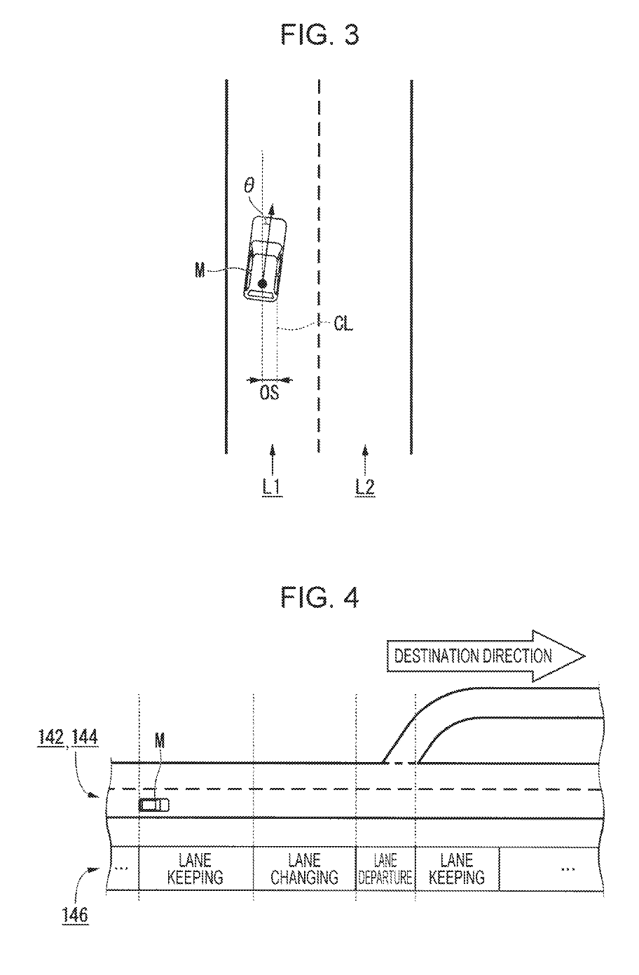

FIG. 3 is a diagram illustrating how the vehicle position recognizing unit 112 recognizes the relative position of the vehicle M in a current lane L1. The vehicle position recognizing unit 112 recognizes, for example, a divergence OS of a reference point (for example, the center of gravity) of the vehicle M from the center CL of the current lane L1 and an angle θ between the direction in which the vehicle M is traveling and the line extending at the center CL of the current lane L1 as the relative position of the vehicle M in the current lane L1. Instead of these parameters, the vehicle position recognizing unit 112 may recognize the position of the reference point of the vehicle M relative to one of the side ends of the current lane L1 as the relative position of the vehicle M in the current lane L1.

The outside recognizing unit 114 recognizes states such as the position, speed, and acceleration of each nearby vehicle on the basis of information input thereto from the rangefinders 20, the radars 30, and the camera 40. In the embodiment, a nearby vehicle is a vehicle that travels near the vehicle M in the same direction as the direction in which the vehicle M travels. The position of the nearby vehicle may be represented by a representative point, such as the center of gravity or corner of the vehicle or may be represented by an area expressed by the outline of the vehicle. The “states” of a nearby vehicle may include acceleration of the nearby vehicle and whether the nearby vehicle is performing (or is about to perform) lane changing depending on the information from the aforementioned various devices. The outside recognizing unit 114 may recognize the positions of other objects, such as guard rails, utility poles, parked vehicles, and pedestrians in addition to the positions of the nearby vehicles.

The action plan generating unit 116 sets the start point of automated driving, the expected end point of automated driving, and/or the destination of automated driving. The start point of automated driving may be the current location of the vehicle M or the point at which the occupant of the vehicle M has performed an operation for instructing automated driving. The action plan generating unit 116 generates an action plan for a section from the start point to the expected end point or a section from the start point to the destination of automated driving. Note that the section is not limited to these sections, and the action plan generating unit 116 may generate an action plan for any given section.

An action plan is composed of a plurality of sequentially performed events, for example. Examples of events include an deceleration event for decelerating the vehicle M, an acceleration event for accelerating the vehicle M, a lane keeping event for causing the vehicle M to travel without departing from the current lane, a lane changing event for changing the lane, an overtaking event for causing the vehicle M to overtake its preceding vehicle, a branching event for causing the vehicle M to change the lane to a desired lane at the branching point or to travel without departing from the current lane at the branching point, and a merging event for accelerating or decelerating the vehicle M on the merging lane for merging with the main lane and then causing the vehicle M to change the lane. For example, if there is a junction (branching point) in a toll road (for example, highway), the vehicle control device 100 causes the vehicle M to change or keep the lane so that the vehicle M travels in the direction of the destination. Accordingly, if the action plan generating unit 116 determines that there is a junction along a path with reference to the map information 142, it sets a lane changing event for changing the lane to a desired lane with which the vehicle M can travel to the direction of the destination within a section from the current location (coordinates) of the vehicle M to the location (coordinates) of the junction. Note that information representing the action plan generated by the action plan generating unit 116 is stored as action plan information 146 in the storage unit 140.

FIG. 4 is a diagram illustrating an example of an action plan generated for a certain section. As illustrated in FIG. 4, the action plan generating unit 116 classifies situations that may be encountered if the vehicle M travels along a path to the destination and generates an action plan so that events corresponding to the respective situations are carried out. Note that the action plan generating unit 116 may dynamically change the action plan in accordance with a change in the situation where the vehicle M is in.

The action plan generating unit 116 may change (update) the generated action plan on the basis of the outside state recognized by the outside recognizing unit 114, for example. In general, the outside state changes all the time while the vehicle is traveling. In particular, in the case where the vehicle M travels on the road having a plurality of lanes, distances to other vehicles change relatively. For example, when a preceding vehicle decelerates in response to sudden braking or a vehicle traveling on the next lane cuts in front of the vehicle M, the vehicle M needs to travel while appropriately changing the speed or lane in accordance with the behavior of the preceding vehicle and the vehicle on the next lane. Accordingly, the action plan generating unit 116 may change the event set for each control section in accordance with the change in the outside state described above.

Specifically, the action plan generating unit 116 changes the event set for a driving section where the vehicle M is expected to travel, if the speed of another vehicle recognized by the outside recognizing unit 114 exceeds a threshold or another vehicle traveling on the next lane moves toward the lane of the vehicle M while the vehicle M is traveling. For example, suppose that events are set such that a lane changing event follows a lane keeping event. In such a case, if the recognition result obtained by the outside recognizing unit 114 during the lane keeping event indicates that a vehicle located behind is traveling at a speed of a threshold or higher on a lane to which a lane change is to be made, the action plan generating unit 116 changes the event that follows the lane keeping event from the lane changing event to a deceleration event or a lane keeping event, for example. As a result, the vehicle control device 100 successfully implements safe automated driving of the vehicle M even if the outside state changes. In the automated driving mode, the speed is adjusted in accordance with the traveling mode, the steering angle, and so forth.

### Lane Keeping Event

When performing a lane keeping event, the action plan generating unit 116 selects a traveling mode from among a constant-speed mode, a follow mode, a deceleration mode, a curve mode, and an obstacle avoiding mode. For example, the action plan generating unit 116 selects the constant-speed mode as the traveling mode when there is no vehicle ahead of the vehicle M. The action plan generating unit 116 selects the follow mode as the traveling mode when the vehicle M follows the preceding vehicle. The action plan generating unit 116 selects the deceleration mode as the traveling mode when deceleration of the preceding vehicle is recognized by the outside recognizing unit 114 or the vehicle M performs a stopping or parking event. The action plan generating unit 116 selects the curve mode as the traveling mode when the outside recognizing unit 114 recognizes that the vehicle M is approaching a curve. The action plan generating unit 116 selects the obstacle avoiding mode as the traveling mode when an obstacle is recognized in front of the vehicle M by the outside recognizing unit 114.

The path generating unit 118 generates a path of the vehicle M on the basis of the traveling mode selected by the action plan generating unit 116. A path is a collection (trajectory) of sampled points obtained by sampling, at predetermined intervals, target locations expected to be reached when the vehicle M travels in the traveling mode selected by the action plan generating unit 116. The path generating unit 118 calculates at least the target speed of the vehicle M on the basis of the speed of the target object located ahead of the vehicle M and the distance from the vehicle M to the target object, which are recognized by the vehicle position recognizing unit 112 and the outside recognizing unit 114. The path generating unit 118 generates a path on the basis of the calculated target speed. Examples of the target object include a preceding vehicle; points such as a merging point, a branching point, and a destination point; and objects such as an obstacle.

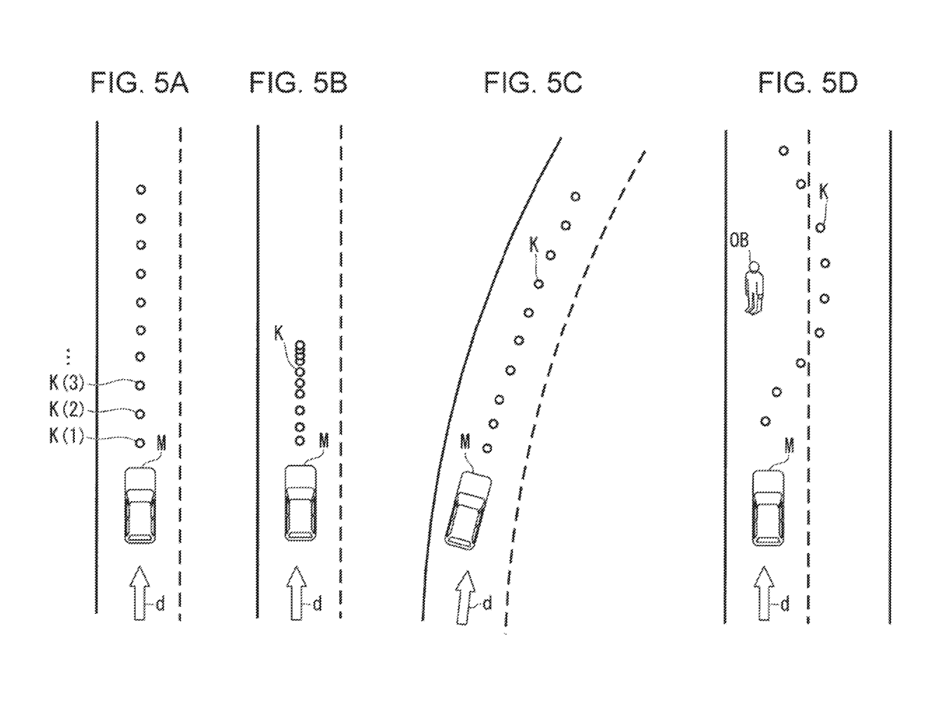

A description will be given of how a path is generated with and without taking the presence of the target object into consideration in the automated driving mode. FIGS. 5A to 5D are diagrams each illustrating an example of a path generated by the path generating unit 118. As illustrated in FIG. 5A, the path generating unit 118 sets expected target locations K(1), K(2), K(3), . . . corresponding to time points at intervals of a predetermined period Δt from the current time as a path of the vehicle M by using the current location of the vehicle M as a reference. Hereinafter, these expected target locations are simply referred to as “expected target locations K” when they are not distinguished from one another. For example, the number of expected target locations K is determined in accordance with a target period T. For example, when the target period T is 5 seconds, the path generating unit 118 sets the expected target locations K along a line extending at the center of the current lane at intervals of the predetermined period Δt (0.1 second, for example) in the target period of 5 seconds and determines the intervals between the plurality of expected target locations K on the basis of the traveling mode. The path generating unit 118 may derive the line extending at the center of the current lane from information concerning the lane width included in the map information 142 or may obtain such information from the map information 142 if the map information 142 includes information concerning the location of the center of the current lane.

For example, when the constant-speed mode is selected as the traveling mode by the action plan generating unit 116, the path generating unit 118 generates a path by setting a plurality of expected target locations K at equal intervals as illustrated in FIG. 5A. In addition, when the deceleration mode is selected as the traveling mode by the action plan generating unit 116 (including the case where the preceding vehicle decelerates when the follow mode is carried out), the path generating unit 118 generates a path by setting the interval between the expected target locations K that are to be reached earlier to be larger and by setting the interval between the expected target locations K that are to be reached later to be smaller as illustrated in FIG. 5B. In such a case, the preceding vehicle; a point such as a merging point, a branching point, or a target point; or an obstacle may be set as an object OB. Since a distance between the current location of the vehicle M at the corresponding time point and an expected target location K that is to be reached by the vehicle M later gradually decreases, the drive control unit 120 (described later) decelerates the vehicle M.

In addition, when the curve mode is selected as the traveling mode, the path generating unit 118 generates a path by arranging the plurality of expected target locations K while changing their positions in a direction perpendicular to the traveling direction of the vehicle M (positions in the lane width direction), for example, in accordance with the curvature of the road as illustrated in FIG. 5C. In addition, when an obstacle, such as a person or a stationary vehicle, is present ahead of the vehicle M on the road as illustrated in FIG. 5D, the action plan generating unit 116 selects the obstacle avoiding mode as the traveling mode. In this case, the path generating unit 118 generates a path by arranging the plurality of expected target locations K such that the vehicle M travels while avoiding this obstacle.

### Lane Changing Event

A lane changing event will be described next. The path generating unit 118 identifies a vehicle that is traveling ahead of the vehicle M on an adjacent lane, which is adjacent to the current lane where the vehicle M is traveling and to which the vehicle M is to move, and identifies a vehicle that is traveling behind the vehicle M on the adjacent lane. The path generating unit 118 then sets a target position range TA between these vehicles. A description will be given below by referring to a vehicle that is traveling ahead of the vehicle M on the adjacent lane as a front reference vehicle and by referring to a vehicle that is traveling behind the vehicle M on the adjacent lane as a rear reference vehicle. The target position range TA is a relative position range based on the positional relationship among the vehicle M, the front reference vehicle, and the rear reference vehicle.

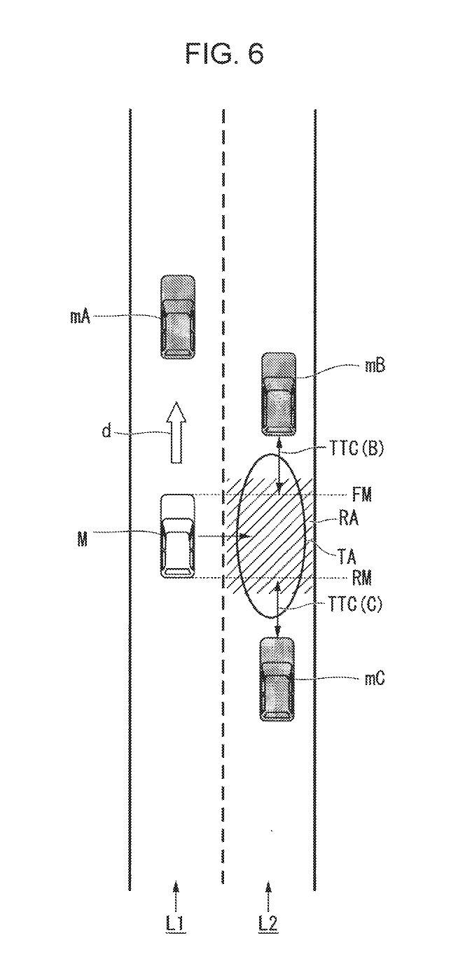

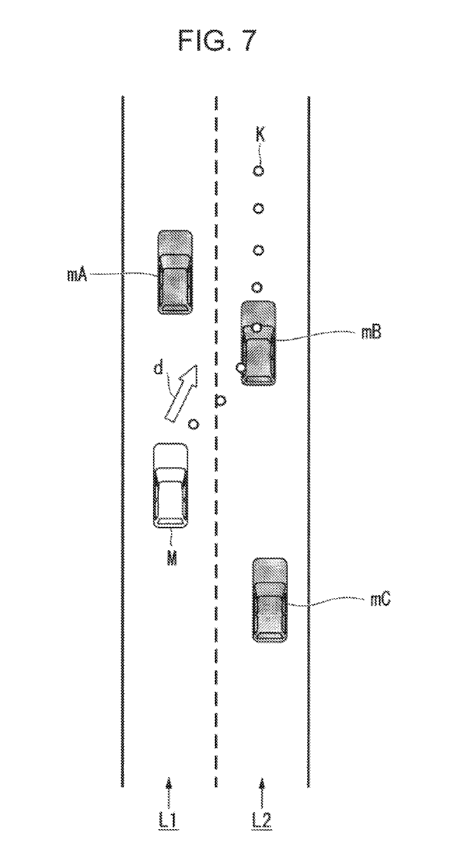

FIG. 6 is a diagram illustrating how the target position range TA is set. FIG. 6 depicts a preceding vehicle mA, a front reference vehicle mB, and a rear reference vehicle mC. FIG. 6 also depicts an arrow d that represents a traveling (moving) direction of the vehicle M, the current lane L1, and an adjacent lane L2. In the case of the example illustrated in FIG. 6, the path generating unit 118 sets the target position range TA between the front reference vehicle mB and the rear reference vehicle mC on the adjacent lane L2.

Then, the path generating unit 118 determines whether it is possible to perform lane changing to the target position range TA (i.e., between the front reference vehicle mB and the rear reference vehicle mC). For example, the path generating unit 118 determines that it is possible to perform lane changing if there is a space where no nearby vehicle is present in a restrained area RA set on the adjacent lane and time-to-collision TTC for the vehicle M and the front reference vehicle mB and time-to-collision TTC for the vehicle M and the rear reference vehicle mC are larger than respective thresholds. If it is determined that it is not possible to perform lane changing, the path generating unit 118 sets the target position range TA again. At that time, a timing at which the target position range TA that satisfies lane changing conditions becomes settable may be waited for, or the target position range TA may be set to be in front of the front reference vehicle mB or behind the rear reference vehicle mC and speed control may be performed so that the vehicle M is located side by side with the target position range TA.

As illustrated in FIG. 6, the path generating unit 118 projects the vehicle M to the adjacent lane L2 to which the vehicle M is to move and sets the restrained area RA having a small marginal distance in front and behind. The restrained area RA is set to extend from one transversal end to the other transversal end of the adjacent lane L2.

If there is no nearby vehicle in the restrained area RA, the path generating unit 118 assumes an extending line FM and an extending line RM that are obtained by virtually extending the front end and the rear end of the vehicle M to the adjacent lane L2 to which the vehicle M is to move, for example. The path generating unit 118 calculates time-to-collision TTC(B) for the extending line FM and the front reference vehicle mB and time-to-collision TTC(C) for the extending line RM and the rear reference vehicle mC. The time-to-collision TTC(B) is derived by dividing the distance between the extending line FM and the front reference vehicle mB by the relative speed between the vehicle M and the front reference vehicle mB. The time-to-collision TTC(C) is derived by dividing the distance between the extending line RM and the rear reference vehicle mC by the relative speed between the vehicle M and the rear reference vehicle mC. The path generating unit 118 determines that it is possible to perform lane changing if the time-to-collision TTC(B) is larger than a threshold Th(B) and the time-to-collision TTC(C) is larger than a threshold Th(C). The thresholds Th(B) and Th(C) may be the same value or different values.

If it is determined that it is possible to perform lane changing, the path generating unit 118 generates a path for lane changing. FIG. 7 is a diagram how a path for lane changing is generated. For example, the path generating unit 118 assumes that the preceding vehicle mA, the front reference vehicle mB, and the rear reference vehicle mC travel in accordance with a predetermined speed model, and generates a path on the basis of the predetermined speed model of these three vehicles and the speed of the vehicle M such that the vehicle M is to be located between the front reference vehicle mB and the rear reference vehicle mC at a certain future time point without interfering with the preceding vehicle mA. For example, the path generating unit 118 smoothly links the current location of the vehicle M and the location of the front reference vehicle mB at the certain future time point or the lane changing end point at the center of the lane to which the vehicle M is to move by using a polynomial curve, such as a spline curve, and arranges the predetermined number of expected target locations K along this curve at equal or unequal intervals. At that time, the path generating unit 118 generates a path such that at least one of the expected target locations K is located within the target position range TA.

Then, the path generating unit 118 determines whether a path that satisfies set conditions has been successfully generated. The set conditions may be, for example, the acceleration/deceleration, the steered angle, and the expected yaw rate at each point along the path being within respective predetermined ranges. If a path that satisfies the set conditions has been successfully generated, the path generating unit 118 outputs information of the path for lane changing to the drive control unit 120 to cause a lane changing to be performed.

### Drive Control

The drive control unit 120 sets the driving mode to the automated driving mode, the manual driving mode, or the like under the control performed by the switching control unit 130, for example, and controls targets including part or all of the driving force output system 90, the steering system 92, and the braking system 94 in accordance with the set driving mode. Note that the drive control unit 120 may appropriately adjust the determined control amounts in accordance with the detection results obtained by the vehicle sensors 60.

If the vehicle M carries out the automated driving mode, the drive control unit 120 controls the driving force output system 90, the steering system 92, and the braking system 94 such that the vehicle M travels along the path generated by the path generating unit 118 at expected timing, for example. If the vehicle M carries out the manual driving mode, the drive control unit 120 outputs operation detection signals input thereto from the operation detection sensors to the driving force output system 90, the steering system 92, and the braking system 94 without processing them, for example. If the vehicle M carries out the semi-automated driving mode, the drive control unit 120 may control the steering system 92 so that the vehicle M travels along the path generated by the path generating unit 118 or may control the driving force output system 90 and the braking system 94 so that the vehicle M travels at a predetermined speed, for example.

During the automated driving mode or the semi-automated driving mode, if the speed of the vehicle M to be achieved as a result of acceleration based on an operation that is performed by the occupant of the vehicle M to accelerate the vehicle M and is received by the aforementioned operation device or the like does not exceed a speed limit that is dependent on the steering angle of the vehicle M, the drive control unit 120 performs control for temporary acceleration based on the operation. The term “speed limit” used herein does not refer to the speed limit in terms of the functionality (mechanically possible maximum speed) of the vehicle M but rather refers to the speed limit set in the automated driving mode.

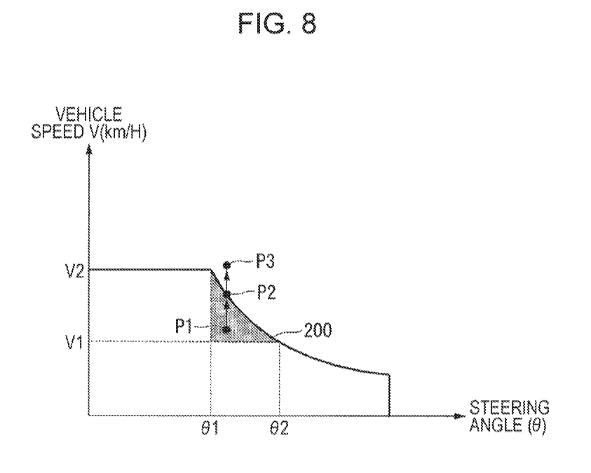

FIG. 8 is a diagram illustrating an example of the speed limit that is dependent on the steering angle. In the example of FIG. 8, the horizontal axis of the graph represents a steering angle θ that is obtained by the steering-wheel steering angle sensor 75 of the vehicle M, and the vertical axis of the graph represents the speed V of the vehicle M. In FIG. 8, a curve 200 represents the speed limit that is dependent on the steering angle. For example, when the steering angle is equal to θ1, the speed limit is equal to V2. For example, when the steering angle is equal to θ2, the speed limit is equal to V1. A relationship (limitation) between the vehicle speed and the steering angle is represented as the predetermined curve 200 in the example of FIG. 8; however, the relationship is not limited to this one and may be set in any given manner in accordance with the vehicle type or the like. The relationship between the vehicle speed and the steering angle may be any relationship as long as the vehicle speed tends to decrease as the steering angle increases. That is, the relationship may be represented by a step-like or line-linked characteristic curve.

It is assumed that a point P1 represents a driving point corresponding to the vehicle speed and the steering angle of the vehicle M at the current time point in the automated driving mode. In this case, when the occupant of the vehicle M operates the accelerator pedal 70, which is an example of the operation device, to temporary accelerate the vehicle M, the speed of the vehicle M is maintained at the speed limit (point P2 in FIG. 8) that is dependent on the steering angle of the vehicle M if the speed of the vehicle M to be achieved as a result of the acceleration exceeds a threshold that is dependent on the steering angle of the vehicle M. The threshold may be equal to the speed limit or a value slightly smaller than the speed limit. In addition, the condition “if the speed of the vehicle M exceeds the threshold that is dependent on the steering angle of the vehicle M” may be replaced with the condition “if the state in which the speed of the vehicle M does not exceed the threshold that is dependent on the steering angle of the vehicle M changes a to the state in which the speed of the vehicle M exceeds the threshold”. In this case, the drive control unit 120 performs temporary acceleration in the automated driving mode such that the resultant speed does not exceed the speed limit of the point P2. In addition, when acceleration is performed to exceed the speed limit of the point P2, for example, up to a speed of a point P3 illustrated in FIG. 8, the drive control unit 120 causes the switching control unit 130 to perform control for shifting from the automated driving mode to the manual driving mode.

In addition, when the occupant of the vehicle M is performing a steering operation on the operation device and the speed of the vehicle M exceeds the speed limit, the drive control unit 120 may permit acceleration to a speed that is higher than or equal to the speed limit and may perform control to terminate the automated driving mode. The state where the steering operation is performed is, for example, the state where the steering-wheel steering angle sensor 75 detects the steering angle in response to rotation of the steering wheel 74, which is an example of the operation device. Such a state may include the state where the occupant of the vehicle M is holding the steering wheel 74.

If the vehicle M is performing lane changing in the automated driving mode, the drive control unit 120 may perform control so that acceleration based on the operation for accelerating the vehicle M received by the operation device is not performed. In addition, the drive control unit 120 may terminate the automated driving mode if the acceleration operation received by the operation device is continued for a predetermined period or longer. The drive control unit 120 may perform control to continue the automated driving mode if the operation period of the acceleration operation is shorter than the predetermined period.

When the above-described limitation is applied for the operation performed by the occupant of the vehicle M in driving control of the vehicle M, the drive control unit 120 may notify the occupant of the vehicle M of information indicating that the operation is limited by using the indicator device 82. For example, if the indicator device 82 is a display unit, such as an LCD (Liquid Crystal Display) or an organic EL (Electroluminescence) of the vehicle M, the drive control unit 120 causes a message indicating that the operation performed by the occupant of the vehicle M is limited to be displayed on the screen of the display unit. Note that the display unit may be a head-up display that displays an image within the field of view of the occupant of the vehicle M by reflecting the image on the front windshield of the vehicle M, a display unit of the navigation system 50, or a display unit of an instrument panel that displays the statuses (such as the speed) of the vehicle M. If the indicator device 82 is a speaker, the drive control unit 120 causes an audio message or an alarming sound indicating that the operation performed by the occupant of the vehicle M is limited to be output from the speaker. If the indicator device 82 is a light-emitting device, such as an LED (Light Emitting Diode) lamp provided in the vehicle M to prompt handover, the drive control unit 120 switches on or blinks the LED lamp that indicates that the operation performed by the occupant of the vehicle M is limited. If the indicator device 82 is a vibrator that vibrates a seat of the vehicle M or the like, the drive control unit 120 causes the vibrator to vibrate the seat where the occupant of the vehicle M is sitting. The drive control unit 120 notifies the occupant of the vehicle M by using at least one of the above notification methods; however, the notification method used is not limited to these method.

### Switching Control

The switching control unit 130 switches the driving mode on the basis of the driving mode specifying signal input thereto from the switch 80. The switching control unit 130 also switches the driving mode on the basis of an operation performed on the operation device for acceleration, deceleration, or steering. The switching control unit 130 performs handover control for shifting from the automated driving mode to the manual driving mode at a location such as a location where the automated driving mode set based on the action plan information 146 is planned to be terminated.

For example, the switching control unit 130 includes a handover control unit 132. The handover control unit 132 instructs the automated driving control unit 110 to perform shifting from the automated driving mode to the manual driving mode if an operation amount and/or an operation period of at least one operation device out of the operation devices such as the accelerator pedal 70, the brake pedal 72, and the steering wheel 74 exceed respective thresholds set for the operation amount and/or the operation period of the operation device and performs control for switching (handover). The operation amount is detectable by using an operation detection sensor corresponding to each operation device (such as the accelerator opening sensor 71, the brake depression amount sensor (brake switch) 73, and the steering-wheel steering angle sensor 75). The operation amount is some or all of the accelerator opening, the brake depression amount, the steering angle of the steering wheel, and the steering torque or an amount of change in these parameters. The operation period is obtainable by measuring a period for which each of the operation devices has been operated, for example. The handover control unit 132 may perform control to perform switching from the automated driving mode to the manual driving mode and terminate the automated driving mode if the change in the vehicle speed of the vehicle M exceeds a predetermined threshold as a result of the operation of the aforementioned operation device(s) (for example, an acceleration operation or a deceleration operation).

### Process Flow

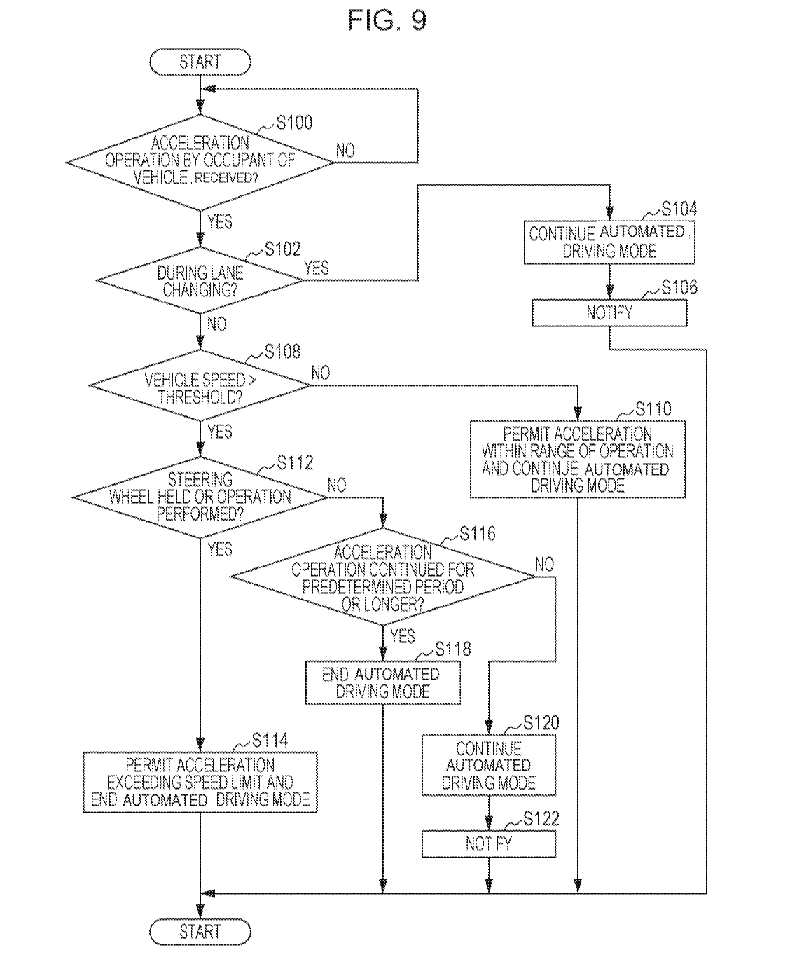

The flow of a process performed by the vehicle control device 100 according to the embodiment will be described below. The following description is given of the flow of a drive control process according to the embodiment out of various processes performed by the vehicle control device 100. FIG. 9 is a flowchart illustrating an example of the drive control process according to the embodiment. Note that the example of FIG. 9 illustrates an example of a process performed in the automated driving mode.

In the example of FIG. 9, the drive control unit 120 stands by until an acceleration operation of depressing the accelerator pedal 70 is received from the occupant of the vehicle M (step S100). In response to the acceleration operation, the drive control unit 120 determines whether the vehicle M is changing the lane in the automated driving mode (step S102). If the vehicle M is changing the lane, the drive control unit 120 continues the automated driving mode (step S104) and notifies, by using the indicator device 82, the occupant of the vehicle M that the acceleration operation is limited (step S106).

If it is determined in the processing of step S102 that the vehicle M is not changing the lane, the drive control unit 120 determines whether the speed of the vehicle M to be achieved as a result of acceleration exceeds a threshold (step S108). If the speed of the vehicle M does not exceed the threshold, the drive control unit 120 permits acceleration within the range of the operation and continues the automated driving mode (step S110). The determination using the threshold may be determination as to “whether the state in which the speed of the vehicle M does not exceed the threshold changes to the state in which the speed exceeds the threshold”.

If the speed of the vehicle M exceeds the threshold, the drive control unit 120 determines whether the occupant of the vehicle M is holding or operating the steering wheel 74 (step S112). If the occupant of the vehicle M is holding or operating the steering wheel 74, the drive control unit 120 permits acceleration that achieves a speed exceeding the threshold, causes the handover control unit 132 to perform shifting to the manual driving mode, and terminates the automated driving mode (step S114).

If the occupant of the vehicle M is not holding or operating the steering wheel 74, the drive control unit 120 determines whether the acceleration operation has been continued for a predetermined period or longer (step S116). If the acceleration operation has been continued for the predetermined period or longer, the drive control unit 120 causes the handover control unit 132 to perform shifting to the manual operation mode and terminates the automated driving mode (step S118). If the acceleration operation has not been continued for the predetermined period or longer, the drive control unit 120 continues the automated driving mode (step S120) and notifies the occupant of the vehicle M that the acceleration operation is limited by using the indicator device 82 (step S122). Control may be performed on the basis of the acceleration operation in the processing of step S120 so that the speed does not exceed the speed limit. In addition, the order of some steps of determination processing (for example, steps S112 and S116) in the process illustrated in FIG. 9 described above may be changed.

The vehicle control system 1, the vehicle control method, and the vehicle control program according to the embodiment described above enable acceleration to be performed temporarily within an appropriate range during automated driving without departing from the driving state where automated driving can be performed appropriately, in the case where temporary acceleration is performed on the basis of an operation performed by the occupant of the vehicle during automated driving.

In addition, temporary acceleration that achieves a speed exceeding the threshold may be permitted in response to an operation performed by the occupant of the vehicle M during automated driving acceleration and the automated driving mode may be terminated if the occupant of the vehicle M is holding or operating the steering wheel 74. In addition, in the embodiment, handover control for terminating the automated driving mode is successfully performed if an acceleration operation has been continued for a predetermined period or longer. As a result, acceleration control in which the intention of the occupant of the vehicle M is respected is successfully implemented, and switching from the automated driving mode to the manual driving mode is successfully performed quickly.

While how the present disclosure is embodied has been described by using the embodiment above, the present disclosure is not limited to such an embodiment, and various modifications or replacements may be made within a scope not departing from the essence of the present disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A vehicle control device comprising:
an automated driving controller that carries out a first driving mode in which at least one of acceleration-and-deceleration and steering of a vehicle is automatically controlled such that the vehicle travels along a route to a destination;
an operation device that receives an operation performed by an occupant of the vehicle;
a handover controller that instructs the automated driving controller to perform shifting to a second driving mode when the occupant of the vehicle performs an operation on the operation device to instruct one of or both of acceleration-and-deceleration and steering of the vehicle while the automated driving controller is carrying out the first driving mode, the second driving mode being a mode in which a degree of automated driving is lower than in the first driving mode; and
a drive controller that performs acceleration according to an operation that is performed by the occupant of the vehicle to accelerate the vehicle and that is received by the operation device, if speed of the vehicle to be achieved as a result of the acceleration according to the operation does not exceed a threshold that is dependent on a steering angle of the vehicle.

2. The vehicle control device according to claim 1, wherein the drive controller maintains the speed of the vehicle at a speed limit that is dependent on the steering angle of the vehicle if the speed of the vehicle to be achieved as a result of the acceleration exceeds the threshold that is dependent on the steering angle of the vehicle.

3. The vehicle control device according to claim 1, wherein the drive controller terminates the first driving mode if the occupant of the vehicle is performing a steering operation on the operation device and the speed of the vehicle exceeds the threshold.

4. The vehicle control device according to claim 1, wherein the drive controller does not perform the acceleration according to the operation that is performed to accelerate the vehicle and that is received by the operation device if the vehicle is performing lane changing in the first driving mode.

5. The vehicle control device according to claim 1, wherein the drive controller:
terminates the first driving mode if the acceleration operation received by the operation device has been continued for a predetermined period or longer, and
continues the first driving mode if an operation period for which the acceleration operation has been continued is shorter than the predetermined period.

6. The vehicle control device according to claim 2, further comprising:
an output unit that outputs information,
wherein the drive controller causes the output unit to output information indicating that acceleration of the vehicle is limited if the speed of the vehicle to be achieved as a result of the acceleration exceeds the threshold that is dependent on the steering angle of the vehicle and the speed of the vehicle is maintained at the speed limit.

7. A vehicle control method performed by a computer mounted in a vehicle, comprising steps of:
carrying out, by the computer, a first driving mode in which at least one of acceleration-and-deceleration and steering of the vehicle is automatically controlled such that the vehicle travels along a route to a destination;
instructing, by the computer, shifting to a second driving mode when an occupant of the vehicle performs an operation on an operation device to instruct one of or both of acceleration-and-deceleration and steering of the vehicle while the first driving mode is being carried out, the second driving mode being a mode in which a degree of automated driving is lower than in the first driving mode, the operation device being a device that receives an operation performed by the occupant of the vehicle; and
performing, by the computer, acceleration according to an operation that is performed by the occupant of the vehicle to accelerate the vehicle and that is received by the operation device, if speed of the vehicle to be achieved as a result of the acceleration according to the operation does not exceed a threshold that is dependent on a steering angle of the vehicle.

8. A non-transitory computer readable medium storing a vehicle control program causing a computer mounted in a vehicle to execute a process, the process comprising steps of:
carrying out a first driving mode in which at least one of acceleration-and-deceleration and steering of the vehicle is automatically controlled such that the vehicle travels along a route to a destination;
instructing shifting to a second driving mode when an occupant of the vehicle performs an operation on an operation device to instruct one of or both of acceleration-and-deceleration and steering of the vehicle while the first driving mode is being carried out, the second driving mode being a mode in which a degree of automated driving is lower than in the first driving mode, the operation device being a device that receives an operation performed by the occupant of the vehicle; and
performing acceleration according to an operation that is performed by the occupant of the vehicle to accelerate the vehicle and that is received by the operation device, if speed of the vehicle to be achieved as a result of the acceleration according to the operation does not exceed a threshold that is dependent on a steering angle of the vehicle.

9. The vehicle control device according to claim 1, wherein the threshold is dependent on the steering angle of the vehicle at the time when the operation device receives the operation of the acceleration.

10. The vehicle control device according to claim 9, wherein the threshold is a value which decreases as the steering angle of the vehicle increases.

11. The vehicle control device according to claim 2, wherein the drive controller:
terminates the first driving mode if the acceleration operation received by the operation device has been continued for a predetermined period or longer, and
enables the acceleration according to the acceleration operation.
